(19) United States
(12) Patent Application Publication
(10) Pub. No.: US 2007/0154022 A1
(43) Pub. Date: Jul. 5, 2007

(54) Echo Cancellation Circuit

(75) Inventors: Akira Iketani, Ota-shi (JP); Hideki Ohashi, Kyoto-shi (JP)

Correspondence Address: SoCAL IP LAW GROUP LLP, 310 N. WESTLAKE BLVD. STE 120, WESTLAKE VILLAGE, CA, 91362, US

(73) Assignee: SANYO ELECTRIC CO., LTD., Osaka (JP)

(21) Appl. No.: 11/614,812

(22) Filed: Dec. 21, 2006

(30) Foreign Application Priority Data
Dec. 22, 2005 (JP) 2005-369850

(51) Int. Cl. H04B 3/20

(52) U.S. Cl. 381/66

(57) ABSTRACT

An echo cancellation circuit that cancels echo generated when an earphone-microphone is used, the earphone-microphone converting an input first analog signal into voice to be output and converting input voice into a second analog signal to be output, the circuit comprising: a cancellation circuit that receives input of first and second analog signals at a first input terminal and input of a third analog signal at a second input terminal, the third analog signal being generated depending on the first analog signal to prevent the first analog signal from being output along with the second analog signal, and that cancels the first analog signal included in the first and second analog signals with the third analog signal to output the first and second analog signals with the first analog signal canceled; a first load circuit disposed between the earphone-microphone and the first input terminal; and a second load circuit corresponding to the first load circuit and a third load circuit corresponding to the impedance of the earphone-microphone, the second and third load circuits being disposed on the side of the second input terminal.

### CROSS-REFERENCE TO RELATED APPLICATION

This application claims the benefit of priority to Japanese Patent Application No. 2005-369850, filed Dec. 22, 2005, of which full contents are incorporated herein by reference.

### BACKGROUND OF THE INVENTION

1. Technical Field

The present invention relates to an echo cancellation circuit.

2. Description of the Related Art

Recently, in communication devices such as portable phones that transmit and receive voice, earphone-microphones come into use, which have an earphone function that converts analog signals transmitted from the other party into voice to be output and a microphone function that converts spoken voice into analog signals to be output (see Japanese Patent Publication No. 3463063).

When using such an earphone-microphone, an analog signal transmitted from the other party is input to the earphone-microphone and an analog signal converted from a spoken voice is output from the earphone-microphone. Since the two analog signals are input and output through the same path, the analog signal transmitted from the other party can be transmitted to the other party along with the analog signal converted from a spoken voice. If the analog signal transmitted from the other party is transmitted to the other party in this way, an echo is generated on the other party.

To prevent the generation of the echo when using the earphone-microphone, for example, the analog signal transmitted from the other party is controlled not to be transmitted to the other party by canceling the analog signal transmitted from the other party with the use of a signal having the phase adjusted to and the amplitude same as those of the analog signal transmitted from the other party (see Japanese Patent Publication No. 3314372).

In a method disclosed in Japanese Patent Publication No. 3314372, the earphone-microphone is connected to one input terminal of a differential amplifier, and the other input terminal receives input of the analog signal having the phase adjusted to and the amplitude same as those of the analog signal transmitted from the other party. The other input terminal is connected to a resistor, inductor, etc., corresponding to the impedance of the earphone-microphone.

However, since the impedance of the earphone-microphone varies depending on the frequency of the input analog signal, a circuit equivalent to the impedance of the earphone-microphone cannot be realized by simply connecting the resistor, inductor, etc. Therefore, although the configuration disclosed in Japanese Patent Publication No. 3314372can cancel the analog signal transmitted from the other party at a certain frequency, the signal cannot effectively be cancelled over the entire frequency band necessary for voice transmission/reception of portable phones, etc., and the echo is generated in bands other than the certain frequency.

### SUMMARY OF THE INVENTION

The present invention was conceived in view of the above situations and it is therefore the object of the present invention to provide an echo cancellation circuit that can effectively prevent an echo regardless of frequency.

In order to achieve the above object, according to a major aspect of the present invention there is provided an echo cancellation circuit that cancels echo generated when an earphone-microphone is used, the earphone-microphone converting an input first analog signal into voice to be output and converting input voice into a second analog signal to be output, the circuit comprising: a cancellation circuit that receives input of first and second analog signals at a first input terminal and input of a third analog signal at a second input terminal, the third analog signal being generated depending on the first analog signal to prevent the first analog signal from being output along with the second analog signal, and that cancels the first analog signal included in the first and second analog signals with the third analog signal to output the first and second analog signals with the first analog signal canceled; a first load circuit disposed between the earphone-microphone and the first input terminal; and a second load circuit corresponding to the first load circuit and a third load circuit corresponding to the impedance of the earphone-microphone, the second and third load circuits being disposed on the side of the second input terminal.

The first load circuit may be a first resistor; and the second load circuit may be a second resistor with the same resistance value as the first resistor.

The third load circuit may include third and fourth resistors and a capacitor; the third resistor and the capacitor may be serially connected and connected in parallel with the second load circuit; and the fourth resistor may be serially connected to the second load circuit.

The first and second analog signals may be input to the earphone-microphone without intervention of the first load circuit and may be input to the first input terminal through the first load circuit; and the third analog signal may be input between the third load circuit and the fourth resistor and may be input to the second input terminal through the third load circuit.

The echo cancellation circuit may further comprise a high-frequency filter circuit disposed between the first load circuit and the earphone-microphone.

The echo cancellation circuit may further comprise a first amplification circuit disposed between the first load circuit and the first input terminal to amplify the first and second analog signals to be output to the first input terminal; and a second amplification circuit disposed between the second load circuit and the second input terminal to amplify the third analog signal to be output to the second input terminal.

The first amplification circuit may include a first filter circuit that attenuates the high-frequency components of the first and second analog signals before amplifying the first and second analog signals; and the second amplification circuit may include a second filter circuit that attenuates the high-frequency component of the third analog signal before amplifying the third analog signal.

The first amplification circuit may include a third filter circuit that outputs the amplified first and second analog signals with the high-frequency components attenuated; and the second amplification circuit may include a fourth filter circuit that outputs the amplified third analog signal with the high-frequency component attenuated.

The other features of the present invention will become apparent from the following description of this specification and the accompanying drawings.

### BRIEF DESCRIPTION OF THE DRAWINGS

To understand the present invention and the advantages thereof more thoroughly, the following description should be referenced in conjunction with the accompanying drawings, in which:

FIG. 1 depicts a configuration example of a voice signal processing circuit including an embodiment of an echo cancellation circuit of the present invention;

FIG. 2 is a block diagram of a configuration example of an amplification circuit 31;

FIG. 3 is a circuit diagram of a configuration example of the amplification circuit 31;

FIG. 4 is a graph of measured impedance characteristics of an earphone of Star Micronics co., ltd.;

FIG. 5 depicts a configuration example of an equivalent circuit of an earphone-microphone;

FIG. 6 is a graph of the impedance characteristics of the equivalent circuit;

FIG. 7 is a configuration example for simulating the configuration shown in FIG. 1 with the use of the equivalent circuit;

FIG. 8 is a graph of changes in V(a)-V(b) depending on frequency;

FIG. 9A depicts another configuration example of a load circuit for suppressing the effect of the impedance changes in an earphone-microphone 10;

FIG. 9B depicts another configuration example of a load circuit for suppressing the effect of the impedance changes in the earphone-microphone 10;

FIG. 9C depicts another configuration example of a load circuit for suppressing the effect of the impedance changes in the earphone-microphone 10;

FIG. 9D depicts another configuration example of a load circuit for suppressing the effect of the impedance changes in the earphone-microphone 10; and

FIG. 10 depicts another configuration example of the voice signal processing circuit.

### DETAILED DESCRIPTION OF THE INVENTION

From the contents of the description and the accompanying drawings, at least the following details will become apparent.

Circuit Configuration

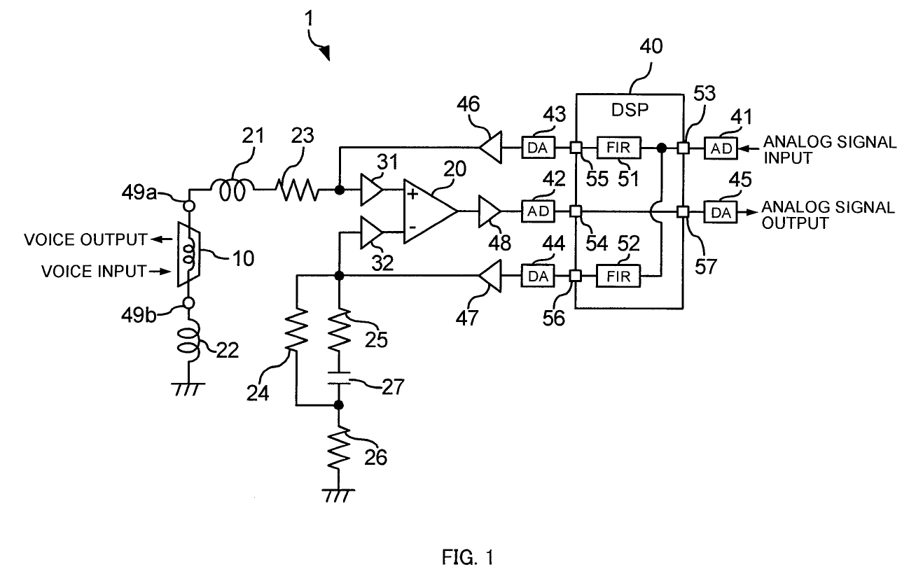

FIG. 1 depicts a configuration example of a voice signal processing circuit including an embodiment of an echo cancellation circuit of the present invention. A voice signal processing circuit 1 includes an earphone-microphone 10, a differential amplifier 20, inductors 21, 22, resistors 23 to 26, a capacitor 27, amplification circuits 31, 32, a Digital Signal Processor (DSP) 40, AD converters 41, 42, DA converters 43 to 45, and amplification circuits 46 to 48. An echo cancellation circuit corresponds to the differential amplifier 20, the inductors 21, 22, the resistors 23 to 26, the capacitor 27, and the amplification circuits 31, 32.

The voice signal processing circuit 1 is used with a communication device such as a portable phone that transmits and receives voice. For example, if the voice signal processing circuit 1 is used with a portable phone, a signal is generated by analog conversion of a signal representing a voice of the other party received by the portable phone and is input from the AD converter 41, and voice converted from this analog signal is output from the earphone-microphone 10. Voice spoken by a user of the portable phone is converted by the earphone-microphone 10 into an analog signal, and the analog signal is output from the DA converter 45 and transmitted to the other party.

The earphone-microphone 10 is a voice input/output device that can be mounted to an ear hole, etc., oscillates an oscillating plate (not shown) based on an analog signal input from the inductor 21 to transmit voice to the inner ear, and detects aerial vibrations in the inner ear generated by speech with the oscillating plate (not shown) to convert the vibrations into an analog signal output to the inductor 21. The earphone-microphone 10 is connected through connection terminals 49a, 49b and is detachable.

The inductors 21, 22 are connected to the earphone-microphone 10 and are high-frequency filters for the input/output of the earphone-microphone 10. When the earphone-microphone 10 is used with a communication device such as a portable phone, a cable with a length on the order of several tens of centimeters is needed and high-frequency noises are superimposed onto the signal input/output to/from the earphone-microphone 10 due to the cable. By disposing the high-frequency filters like the inductors 21, 22, these high-frequency noises can be removed.

The resistor 23 is a load circuit disposed between the earphone-microphone 10 and one input terminal (a first input terminal: a +input terminal in this example) of the differential amplifier 20 and corresponds to a first load circuit (first resistor) of the present invention. As shown in FIG. 1, the resistor 23 is disposed between the inductor 21 and the amplification circuit 31. The analog signal output from the amplification circuit 46 is input between the resistor 23 and the amplification circuit 31. Therefore, the analog signal output from the amplification circuit 46 is input to the earphone-microphone 10 through the resistor 23, and the analog signal output from the earphone-microphone 10 is input to the +input terminal of the differential amplifier 20 through the resistor 10 and the amplification circuit 31. When the resistor 23 is disposed between the earphone-microphone 10 and the amplification circuit 31, the analog signal output from the earphone-microphone 10 to the amplification circuit 31 is attenuated. However, from the viewpoint of the differential amplifier 20, this suppresses the effect of the impedance changes in the earphone-microphone 10 associated with frequency changes in the analog signal input to the earphone-microphone 10.

The resistor 24 is a load circuit disposed correspondingly to the resistor 23 and is disposed on the side of the other input terminal (a second input terminal: a −input terminal in this example) of the differential amplifier 20. The resistor 24 corresponds to a second load circuit (second resistor) of the present invention.

The resistors 25, 26 and the capacitor 27 are a load circuit corresponding to the impedance of the earphone-microphone 10 and are disposed on the—input terminal side of the differential amplifier 20. The load circuit configured by the resistors 25, 26 and the capacitor 27 corresponds to a third load circuit of the present invention. The resistor 25 corresponds to a third resistor of the present invention and the resistor 26 corresponds to a fourth resistor of the present invention.

In this embodiment, the resistor 25, the capacitor 27, and the resistor 26 are serially connected in this order, and the resistor 24 is connected in parallel with the resistor 25 and the capacitor 27 and is serially connected to the resistor 26. The resistors 24, 25 are connected to the amplification circuit 32 and the analog signal output from the amplification circuit 47 is input to this connection point. The disposed positions of the resistor 25 and the capacitor 27 may be interchanged.

The amplification circuit 31 is a circuit that amplifies and outputs the analog signal attenuated by the resistor 23 and corresponds to a first amplification circuit of the present invention. The amplification circuit 31 can remove a high-frequency component before and after amplifying the analog signal. The configuration of the amplification circuit 31 will be described later.

The amplification circuit 32 is a circuit that amplifies the analog signal output from the amplification circuit 47 with the same gain as the amplification circuit 31 and corresponds to a second amplification circuit of the present invention. By disposing the amplification circuit 32 in this way, the same amplitude can be achieved in the analog signals input to the +and −input terminals of the differential amplifier 20. The configuration of the amplification circuit 32 is the same as the amplification circuit 31 and will be described in connection with the amplification circuit 31 later.

The differential amplifier 20 is a circuit that amplifies and outputs a difference between the analog signal input to the +input terminal and the analog signal input to the −input terminal. The analog signal input to the +input terminal of the differential amplifier 20 includes the analog signal output from the amplification circuit 46 and the analog signal output from the earphone-microphone 10. The analog signal input to the −input terminal of the differential amplifier 20 is the analog signal output from the amplification circuit 47. The analog signal output from the amplification circuit 47 is a signal for canceling the analog signal output from the amplification circuit 46. That is, the differential amplifier 20 is a circuit that cancels the analog signal output from the amplification circuit 46 to output the analog signal output from the earphone-microphone 10 and corresponds to the cancellation circuit of the present invention.

The DSP 40 is a circuit that performs various digital signal processes and includes Finite Impulse Response (FIR) filters 51, 52, input terminals 53, 54, and output terminals 55 to 57. Each FIR filter 51, 52 retains a filter coefficient and performs a convolution calculation process for an input digital signal based on the filter coefficient to output the signal.

The AD converters 41, 42 are circuits that convert the input analog signals into digital signals to be output. The DA converters 43 to 45 are circuits that convert the input digital signals into analog signals to be output.

The AD converter 41 receives input of the analog signal representing the voice transmitted from the other party. The digital signal output from the AD converter 41 is input to the FIR filters 51, 52 in the DSP 40 through the input terminal 53. The digital signal output from the FIR filter 51 is input to the DA converter 43 through the output terminal 55. The digital signal output from the FIR filter 52 is input to the DA converter 44 through the output terminal 56.

The amplification circuits 46 to 48 are circuits that amplify and output the input analog signals. The amplification circuit 46 amplifies and outputs the analog signal output from the DA converter 43. The amplification circuit 47 amplifies and outputs the analog signal output from the DA converter 44. The amplification circuit 48 amplifies and outputs the analog signal output from the differential amplifier 20.

The AD converter 42 receives input of the analog signal output from the amplification circuits 48. The digital signal output from the AD converter 42 is input to the DSP 40 through the input terminal 54. If transmission and reception of voice are in process, the digital signal input from the input terminal 54 is output from the output terminal 57 and input to the DA converter 45. The analog signal output from the DA converter 45 in this situation represents the voice detected by the earphone-microphone 10.

The DSP 40 performs a setting process of the filter coefficients of the FIR filters 51, 52 based on the digital signal input from the input terminal 54. When performing the filter coefficient setting process, the DSP 40 outputs an impulse from the output terminal 55 and measures an impulse response (IR1(Z)) from the output terminal 55 to the input terminal 54. Similarly, the DSP 40 outputs an impulse from the output terminal 56 and measures an impulse response (IR2(Z)) from the output terminal 56 to the input terminal 54. The DSP 40 sets the filter coefficient of the FIR filter 51 as -IR2(Z) obtained by phase inversion of IR2(Z) and sets the filter coefficient of the FIR filter 52 as IR1(Z).

Assuming that IR1_ALL(Z) is an impulse response from the input of the FIR filter 51 to the input terminal 54, that IR2_ALL(Z) is an impulse response from the input of the FIR filter 52 to the input terminal 54, that IR1′(Z) is an impulse response from the output terminal 55 to the +input terminal of the differential amplifier 20, that IR2′(Z) is an impulse response from the output terminal 56 to the −input terminal of the differential amplifier 20, and that W(Z) is an impulse response from the ±input terminals of the differential amplifier 20 to the input terminal 54, the following relationship is satisfied.
IR1_ALL(Z)
=(−IR2(Z))·IR1(Z)
=(−(IR2′(Z)·W(Z)))·(IR1′(Z)·W(Z))
=IR2′(Z)·W(Z)·IR1′(Z)·W(Z)
IR2_ALL(Z)
=IR1(Z)·IR2(Z)
=IR1′(Z)·W(Z)·(−IR2′(Z)·W(Z))
=IR1′(Z)·W(Z)·(−IR2′(Z))·W(Z)
=−IR1_ALL

That is, mutually canceling characteristics exist in the impulse response IR1_ALL(Z) from the input of the FIR filter 51 to the input terminal 54 and the impulse response IR2_ALL(Z) from the input of the FIR filter 52 to the input terminal 54. Therefore, by setting the filter coefficients of the FIR filters 51, 52 in this way, the analog signal output from the amplification circuit 46 can be cancelled by the analog signal output from the amplification circuit 47. The filter coefficient setting process is performed at an appropriate timing such as at the time of power-on or factory shipment or when instructed by a user.

Although the FIR filters 51, 52 are used in this embodiment to generate the analog signal for canceling the analog signal transmitted from the other party and to input the signal to the differential amplifier 20, the present invention is not limited to this configuration. For example, as shown in Japanese Patent Publication No. 3314372, a digital filter such as the FIR filter may not be used. However, if the digital filter is used as shown in this embodiment, the phases can highly accurately be adjusted to effectively cancel the analog signal.

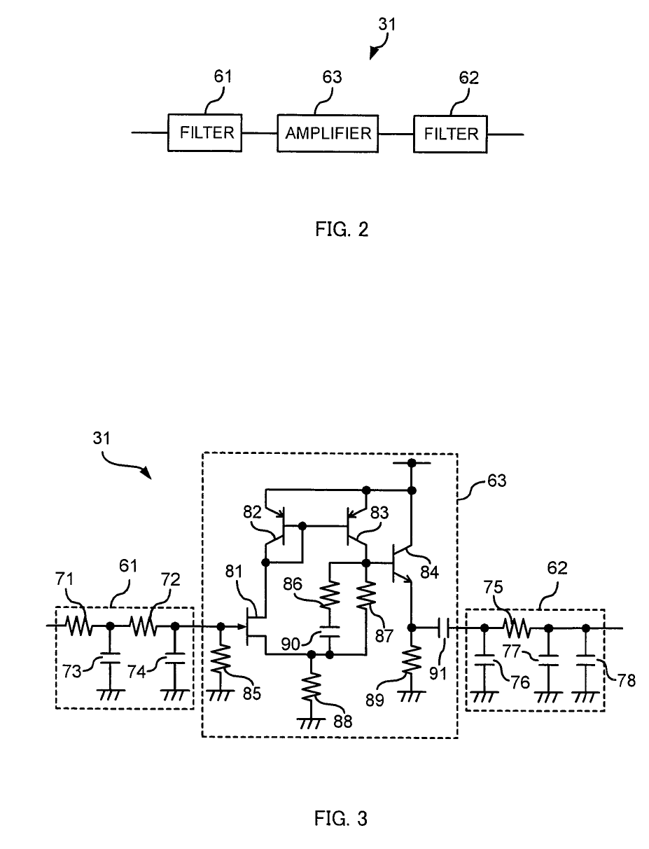

FIG. 2 is a block diagram of a configuration example of the amplification circuit 31. The amplification circuit 32 has the same configuration. The amplification circuit 31 includes filters 61, 62 and an amplifier 63. The filters 61, 62 are circuits that attenuate the high-frequency component of the input analog signal to output the signal. The amplifier 63 is a circuit that amplifies and outputs the input analog signal. First, the filter 61 attenuates the high-frequency component. This is performed to prevent the amplifier 63 at the subsequent state from amplifying the unnecessary high-frequency component. After the high-frequency component of the filter 61 is attenuated, the amplifier 63 amplifies the analog signal. The filter 62 attenuates the high-frequency component again. This is performed to cut the unnecessary high-frequency component and to relatively enhance the signal level of the bass area, which is difficult to be heard.

FIG. 3 is a circuit diagram of a configuration example of the amplification circuit 31. The filter 61 includes the resistors 71, 72 and capacitors 73, 74. The filter 62 includes a resistor 75 and capacitors 76 to 78. The amplifier 63 includes an N-FET 81, PNP transistors 82, 83, an NPN transistor 84, resistors 85 to 89, and capacitors 90, 91. The capacitor 90 in the amplifier 63 is a filter that attenuates a range higher than 3 kHz, for example. The capacitor 91 in the amplifier 63 is a filter that attenuates a range lower than 50 Hz, for example. That is, the amplifier 63 limits the band with the characteristics of the capacitors 90, 91. The configuration shown in FIG. 3 is an example and does not limit the configuration of the amplification circuit 31.

The operation of the voice signal processing circuit 1 will be described. The analog signal representing the voice transmitted from the other party is output through the AD converter 41, the FIR filter 51, the DA converter 43, and the amplification circuit 46. An analog signal (a first analog signal) output from the amplification circuit 46 is input to the earphone-microphone 10 through the resistor 23 and the inductor 21 and the earphone-microphone 10 outputs the voice of the other party. The analog signal (the first analog signal) output from the amplification circuit 46 is input to the +input terminal of the differential amplifier 20 through the amplification circuit 31. The earphone-microphone 10 converts the aerial vibrations in the inner ear generated by speech into an analog signal (a second analog signal) and outputs the signal. The analog signal (the second analog signal) output from the earphone-microphone 10 is input to the +input terminal of the differential amplifier 20 through the inductor 21, the resistor 23, and the amplification circuit 31.

The analog signal representing the voice transmitted from the other party is output through the AD converter 41, the FIR filter 52, the DA converter 44, and the amplification circuit 47. An analog signal (a third analog signal) output from the amplification circuit 47 is input to the −input terminal of the differential amplifier 20 through the amplification circuit 32. In the differential amplifier 20, the analog signal output from the amplification circuit 46 is canceled by the analog signal output from the amplification circuit 47, and the differential amplifier 20 outputs the analog signal to be output from the earphone-microphone 10. The analog signal output from the differential amplifier 20 is transmitted to the other party through the amplification circuit 48, the AD converter 42, the DSP 40, and the DA converter 45.

In the voice signal processing circuit 1, the resistor 23 is disposed to suppress the effect of the impedance changes in the earphone-microphone 10 associated with frequency changes in the input analog signal. Therefore, the input analog signal can accurately be cancelled not only at a certain frequency but also in a wide range of frequencies.

Since the voice signal processing circuit 1 is disposed with the high-frequency filter including the inductors 21, 22, the noises superimposed due to the effect of the cable of the earphone-microphone 10 can be removed.

Although the analog signal output from the earphone-microphone 10 is attenuated by disposing the resistor 23 in the voice signal processing circuit 1, the amplification with the amplification circuit 31 can prevent the level of the analog signal transmitted to the other party from dropping.

Since the amplification circuit 31 attenuates the unnecessary high-frequency component with the filter 61 before amplifying the analog signal, noises can be prevented from being amplified.

Since the amplification circuit 31 attenuates the unnecessary high-frequency component with the filter 62, noises emphasized by the amplification can be removed and bass can be emphasized.

Simulation

Description will be made of a simulation result showing that the effect of the impedance changes in the earphone-microphone 10 associated with frequency changes in the input analog signal is suppressed by disposing the resistor 23 in the voice signal processing circuit 1.

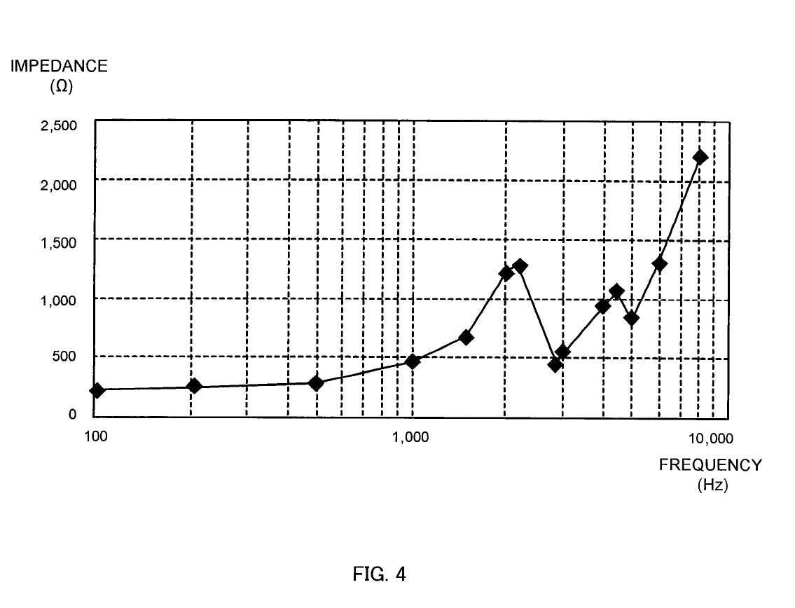

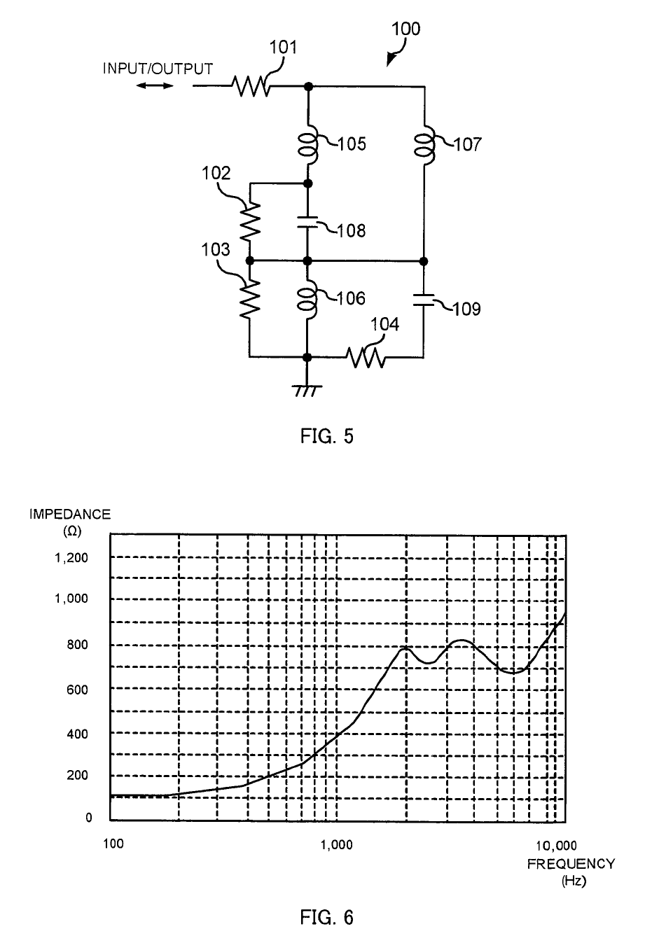

Impedance characteristics of an earphone of Star Micronics co., ltd. were measured for reference of the impedance characteristics of the earphone-microphone 10. FIG. 4 is a graph of the measured impedance characteristics of the earphone of Star Micronics co., ltd. An equivalent circuit of the earphone-microphone 10 was configured so as to exhibit such impedance characteristics. FIG. 5 depicts a configuration example of an equivalent circuit of an earphone-microphone 10. An equivalent circuit 100 includes resistors 101 to 104, inductors 105 to 107, and capacitors 108, 109. In this simulation, the resistor 101 is 100 Ω; the resistor 102 is 1500 Ω; the resistor 103 is 2000 Ω; the resistor 104 is 300 Ω; the inductors 105, 107 are 30 mH; the inductor 106 is 20 mH; and the capacitors 108, 109 are 0.1 μF.

FIG. 6 is a graph of the impedance characteristics of the equivalent circuit 100. Although the graph of FIG. 6 is not exactly identical to the graph of FIG. 4 by comparison, it can be seen that general tendencies are identical. Therefore, a simulation was performed with the use of the equivalent circuit 100 shown FIG. 5.

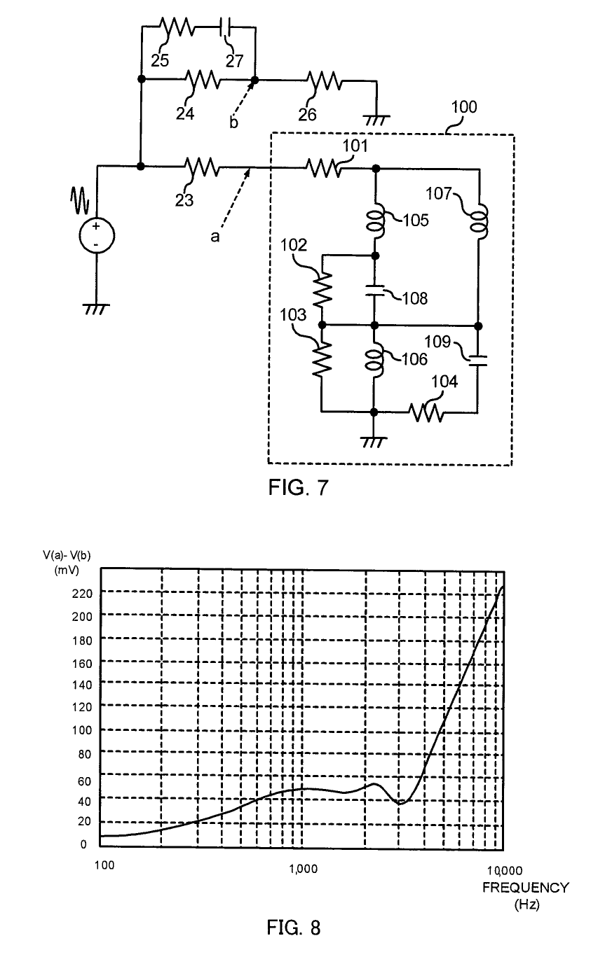

FIG. 7 is a configuration example for simulating the configuration shown in FIG. 1 with the use of the equivalent circuit 100. In this configuration, the resistor 23 and the equivalent circuit 100 are serially connected, and the resistor 24 and the resistor 26 are serially connected to simulate the configuration of FIG. 1. The resistor 25 and the capacitor 27 serially connected are connected in parallel with the resistor 24. For example, 1000-mV analog signal is input to the resistors 23, 24.

In this configuration, differences between a voltage V(a) at an a-point and a voltage V(b) at a b-point were measured while changing the frequency of the analog signal input from the resistors 23, 24. If V(a)-V(b) is small regardless of frequency, it can be said that the effect is suppressed with regard to the impedance changes in the equivalent circuit 100 (the earphone-microphone 10) due to frequency changes in the input analog signal.

FIG. 8 is a graph of changes in V(a)-V(b) depending on frequency. As seen from FIG. 8, V(a)-V(b) is suppressed to small values, about 60 mV, in the range from 100 Hz to about 3 kHz. The voice band transmitted/received by portable phones, etc., is on the order of 500 Hz to 3 kHz. That is, applying to the voice signal processing circuit 1, the effect is suppressed with regard to the impedance changes in the earphone-microphone 10 due to frequency changes in the analog signal representing the voice transmitted from the other party, from the viewpoint of the differential amplifier 20. That is, in the voice signal processing circuit 1, the accuracy of the cancellation by the differential amplifier 20 is improved regardless of the frequency of the analog signal representing the voice transmitted from the other party. Therefore, the voice signal processing circuit 1 effectively prevents the echo regardless of frequency.

### Other Embodiments

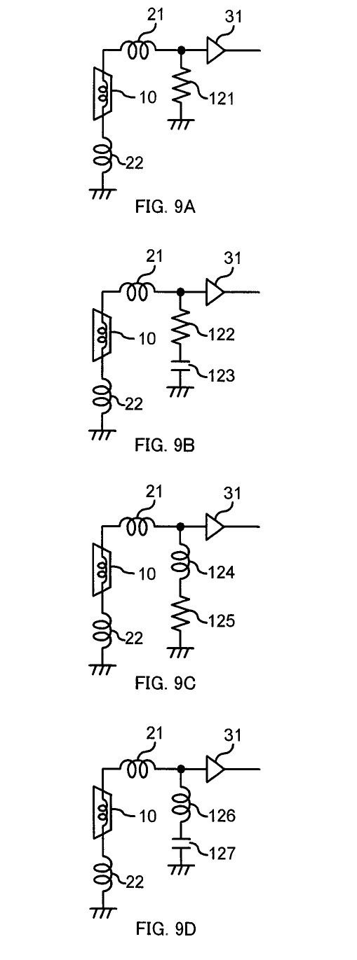

Other embodiment of the voice signal processing circuit 1 shown in FIG. 1 will be described. Although the resistor 23 is used in the voice signal processing circuit 1 shown in FIG. 1 as a load circuit for suppressing the effect of the impedance changes in the earphone-microphone 10, this is not a limitation of the load circuit. FIGS. 9A to 9D depict other configuration examples of the load circuit for suppressing the effect of the impedance changes in the earphone-microphone 10. As shown in FIG. 9A, a resistor 121 may be disposed as the load circuit for suppressing the effect of the impedance changes in the earphone-microphone 10. As shown in FIG. 9B, a resistor 122 and a capacitor 123 may be disposed as the similar load circuit. As shown in FIG. 9C, an inductor 124 and a resistor 125 may be disposed as the similar load circuit. As shown in FIG. 9D, an inductor 126 and a capacitor 127 may be disposed as the similar load circuit.

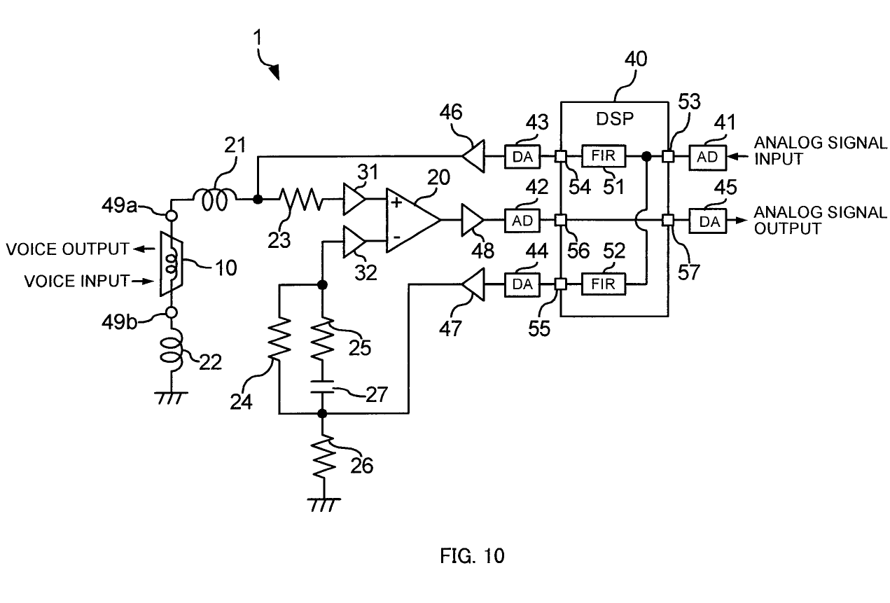

FIG. 10 depicts another configuration example of the voice signal processing circuit 1. Although the analog signal output from the amplification circuit 46 is input between the resistor 23 and the amplification circuit 31 in the configuration shown in FIG. 1, the analog signal can also be input between the inductor 21 and the resistor 23, that is, between the earphone-microphone 10 and the resistor 23, as shown in FIG. 10. In this case, as shown in FIG. 10, the analog signal output from the amplification circuit 47 is input between the resistor 24 and the resistor 26. By imputing the analog signal output from the amplification circuit 46 between the earphone-microphone 10 and the resistor 23 in this way, the analog signal representing the voice transmitted from the other party is input to the earphone-microphone 10 without attenuation due to the resistor 23. Therefore, the output level is improved in the other party's voice output from the earphone-microphone 10.

The voice signal processing circuit 1 of the embodiments has been described. As described above, since the resistor 23 acting as the load circuit is disposed between the earphone-microphone 10 and the differential amplifier 20 in the voice signal processing circuit 1, the effect is suppressed with regard to the impedance changes in the earphone-microphone 10 depending on frequency changes in the input analog signal. Therefore, differential amplifier 20 can accurately cancel the input analog signal to prevent the echo effectively regardless of the frequency of the input analog signal.

Since the resistors 25, 26 and the capacitor 27 configure the load circuit corresponding to the earphone-microphone 10, the impedance characteristics can approximate those of the earphone-microphone 10. Therefore, by disposing the resistor 23 and configuring the load circuit corresponding to the earphone-microphone 10 with the resistors 25, 26 and the capacitor 27, the cancellation accuracy of the differential amplifier 20 can be improved to prevent the echo effectively.

As shown in FIG. 10, by inputting the analog signal output from the amplification circuit 46 to the earphone-microphone 10 without intervention of the resistor 23, the output level is improved in the voice output from the earphone-microphone 10.

By disposing the high-frequency filter including the inductors 21, 22, the noises superimposed due to the effect of the cable, etc., of the earphone-microphone 10 can be removed.

Although the analog signal output from the earphone-microphone 10 is attenuated by the resistor 23, the amplification with the amplification circuit 31 can prevent the level of the analog signal transmitted to the other party from dropping.

Since the amplification circuit 31 attenuates the unnecessary high-frequency component with the filter 61 before amplifying the analog signal, noises can be prevented from being amplified.

Since the amplification circuit 31 attenuates the unnecessary high-frequency component with the filter 62, noises emphasized by the amplification can be removed and bass can be emphasized.

The above embodiments are for the purpose of facilitating the understanding of the present invention and do not limit the interpretation of the present invention. The present invention may be changed/altered without departing from the spirit thereof and the present invention includes the equivalents thereof.

For example, the earphone-microphone 10 can be replaced with a speaker which inputs and outputs voices outside the ear in the same way as the earphone-microphone 10 does.

What is claimed is:

1. An echo cancellation circuit that cancels echo generated when an earphone-microphone is used, the earphone-microphone converting an input first analog signal into voice to be output and converting input voice into a second analog signal to be output, the circuit comprising:
a cancellation circuit that receives input of first and second analog signals at a first input terminal and input of a third analog signal at a second input terminal, the third analog signal being generated depending on the first analog signal to prevent the first analog signal from being output along with the second analog signal, and that cancels the first analog signal included in the first and second analog signals with the third analog signal to output the first and second analog signals with the first analog signal canceled;
a first load circuit disposed between the earphone-microphone and the first input terminal; and
a second load circuit corresponding to the first load circuit and a third load circuit corresponding to the impedance of the earphone-microphone, the second and third load circuits being disposed on the side of the second input terminal.

2. The echo cancellation circuit of claim 1, wherein
the first load circuit is a first resistor, and wherein
the second load circuit is a second resistor with the same resistance value as the first resistor.

3. The echo cancellation circuit of claim 1, wherein
the third load circuit includes third and fourth resistors and a capacitor, wherein
the third resistor and the capacitor are serially connected and connected in parallel with the second load circuit, and wherein
the fourth resistor is serially connected to the second load circuit.

4. The echo cancellation circuit of claim 2, wherein
the third load circuit includes third and fourth resistors and a capacitor, wherein
the third resistor and the capacitor are serially connected and connected in parallel with the second load circuit, and wherein
the fourth resistor is serially connected to the second load circuit.

5. The echo cancellation circuit of claim 3, wherein
the first and second analog signals are input to the earphone-microphone without intervention of the first load circuit and are input to the first input terminal through the first load circuit, and wherein
the third analog signal is input between the third load circuit and the fourth resistor and is input to the second input terminal through the third load circuit.

6. The echo cancellation circuit of claim 4, wherein
the first and second analog signals are input to the earphone-microphone without intervention of the first load circuit and are input to the first input terminal through the first load circuit, and wherein
the third analog signal is input between the third load circuit and the fourth resistor and is input to the second input terminal through the third load circuit.

7. The echo cancellation circuit of claim 1, further comprising:
a high-frequency filter circuit disposed between the first load circuit and the earphone-microphone.

8. The echo cancellation circuit of claim 5, further comprising:
a high-frequency filter circuit disposed between the first load circuit and the earphone-microphone.

9. The echo cancellation circuit of claim 6, further comprising:
a high-frequency filter circuit disposed between the first load circuit and the earphone-microphone.

10. The echo cancellation circuit of claim 1, further comprising:
a first amplification circuit disposed between the first load circuit and the first input terminal to amplify the first and second analog signals to be output to the first input terminal; and
a second amplification circuit disposed between the second load circuit and the second input terminal to amplify the third analog signal to be output to the second input terminal.

11. The echo cancellation circuit of claim 5, further comprising:
a first amplification circuit disposed between the first load circuit and the first input terminal to amplify the first and second analog signals to be output to the first input terminal; and
a second amplification circuit disposed between the second load circuit and the second input terminal to amplify the third analog signal to be output to the second input terminal.

12. The echo cancellation circuit of claim 6, further comprising:
a first amplification circuit disposed between the first load circuit and the first input terminal to amplify the first and second analog signals to be output to the first input terminal; and
a second amplification circuit disposed between the second load circuit and the second input terminal to amplify the third analog signal to be output to the second input terminal.

13. The echo cancellation circuit of claim 10, wherein
the first amplification circuit includes a first filter circuit that attenuates the high-frequency components of the first and second analog signals before amplifying the first and second analog signals, and wherein
the second amplification circuit includes a second filter circuit that attenuates the high-frequency component of the third analog signal before amplifying the third analog signal.

14. The echo cancellation circuit of claim 11, wherein
the first amplification circuit includes a first filter circuit that attenuates the high-frequency components of the first and second analog signals before amplifying the first and second analog signals, and wherein
the second amplification circuit includes a second filter circuit that attenuates the high-frequency component of the third analog signal before amplifying the third analog signal.

15. The echo cancellation circuit of claim 12, wherein
the first amplification circuit includes a first filter circuit that attenuates the high-frequency components of the first and second analog signals before amplifying the first and second analog signals, and wherein
the second amplification circuit includes a second filter circuit that attenuates the high-frequency component of the third analog signal before amplifying the third analog signal.

16. The echo cancellation circuit of claim 10, wherein
the first amplification circuit includes a third filter circuit that outputs the amplified first and second analog signals with the high-frequency components attenuated, and wherein
the second amplification circuit includes a fourth filter circuit that outputs the amplified third analog signal with the high-frequency component attenuated.

17. The echo cancellation circuit of claim 11, wherein
the first amplification circuit includes a third filter circuit that outputs the amplified first and second analog signals with the high-frequency components attenuated, and wherein
the second amplification circuit includes a fourth filter circuit that outputs the amplified third analog signal with the high-frequency component attenuated.

18. The echo cancellation circuit of claim 12, wherein
the first amplification circuit includes a third filter circuit that outputs the amplified first and second analog signals with the high-frequency components attenuated, and wherein
the second amplification circuit includes a fourth filter circuit that outputs the amplified third analog signal with the high-frequency component attenuated.

19. The echo cancellation circuit of claim 13, wherein
the first amplification circuit includes a third filter circuit that outputs the amplified first and second analog signals with the high-frequency components attenuated, and wherein
the second amplification circuit includes a fourth filter circuit that outputs the amplified third analog signal with the high-frequency component attenuated.

20. The echo cancellation circuit of claim 14, wherein
the first amplification circuit includes a third filter circuit that outputs the amplified first and second analog signals with the high-frequency components attenuated, and wherein
the second amplification circuit includes a fourth filter circuit that outputs the amplified third analog signal with the high-frequency component attenuated.
